(19) United States
(12) Patent Application Publication
(10) Pub. No.: US 2020/0254901 A1
(43) Pub. Date: Aug. 13, 2020

(54) DEVICE FOR POWER MANAGEMENT, CONTAINER, ASSOCIATED DELIVERY VEHICLE AND SYSTEM

(71) Applicant: VOLVO TRUCK CORPORATION, Göteborg (SE)

(72) Inventor: Hugues LEGER, St Alban de Roche (FR)

(73) Assignee: VOLVO TRUCK CORPORATION, Göteborg (SE)

(21) Appl. No.: 16/755,454

(22) PCT Filed: Oct. 31, 2017
(86) PCT No.: PCT/IB2017/001431

§ 371 Date: Apr. 10, 2020

(51) Int. Cl. B60L 58/21; B60L 58/12; B60P 3/00; G01C 21/34; G06Q 10/08

(52) U.S. Cl. CPC B60L 58/21; B60L 58/12; B60P 3/007; B60K 6/28; G06Q 10/08355; B60L 2200/36; B60L 2240/62; G01C 21/343

(57) ABSTRACT

The invention concerns the source of electrical energy management module (16) of a hybrid or an electric vehicle (10) comprising several containers (11a-11b), each container (11a-11b) including at least one source of electrical energy (14a-14b) connected to the traction system (12) of said vehicle (10), wherein said source of electrical energy management module (16) includes: means of analysis that are configured to obtain the state of charge of each source of electrical energy (14a-14b) of a vehicle (10); means of selecting at least one source of electrical energy (14a-14b) intended for the traction of a vehicle (10), wherein said selection is made so that the electric power is drawn off as a priority from the source of electrical energy (14a-14b) of the container (11a-11b) to be delivered next by said vehicle (10) if the state of charge of this source of electrical energy (14a-14b) is sufficient.

### TECHNICAL FIELD

This invention concerns the area of goods transport and, more specifically, transport by a hybrid or an electric vehicle.

The invention is particularly adapted for reducing the electric consumption of an electric or a hybrid truck transporting several goods containers.

### BACKGROUND OF THE INVENTION

To deliver traders in a built-up area, a vehicle including several independent goods containers is often used. The vehicle may consist of a small truck and the goods containers can be pallets, boxes, containers, high-capacity sacks etc. Generally, the vehicle is loaded in a warehouse then makes successive deliveries to several traders, delivering one goods container per trader.

The use of an electric vehicle is a desirable way of improving power economy and reducing greenhouse gas emissions in built up areas. To set the size of the source of electrical energy of an electric vehicle, there is a known method of taking the route to be travelled by the vehicle and the maximum load to be carried by the vehicle into consideration. However, when the vehicle delivers the goods containers, the vehicle load decreases and the vehicle continues to carry the weight of the source of electrical energy. Accordingly, when the vehicle has delivered the goods containers and is returning to the warehouse, the power economy of the vehicle is considerably impacted by the weight of the source of electrical energy. During this phase, it can be considered that the power consumed by the vehicle due its transporting the source of electrical energy is inefficient.

The document FR 2737694 describes an electric bus transport system in which the buses have side cases wherein removable batteries are stored for powering the buses.

The system includes a recharging station in which the removable batteries of the bus are replaced by fully recharged batteries. This document proposes the sizing of the bus batteries according to the route to be travelled by the bus, but does not concern goods transport.

The document GB 2512406 describes a method of transporting a container between two warehouses. The container includes a power storage unit which is recharged during transport, by a turbine or an alternator. When the container is stored in a warehouse, it is connected to the electric network of the warehouse and electrically powers the warehouse. This document does not optimise the electricity consumption of the truck carrying the container because the consumption of the truck is increased by the resistance due to the alternator or the turbine.

The technical issue facing the invention is therefore that of optimising the electrical consumption of an electric vehicle with the route of the vehicle and the load it carries.

### OUTLINE OF THE INVENTION

This invention proposes to address this technical issue by using a hybrid or an electric vehicle in which the electric power needed to transport each container is incorporated into the containers transported by the vehicle.

Accordingly, when the containers are delivered, the vehicle only transports the necessary sources of electrical energy and the electric consumption of the vehicle is reduced.

To achieve this function, the vehicle includes an energy management module capable of controlling the use of one or another of the sources of electrical energy of the containers depending on the point of delivery of each container and the charge condition of these sources of electrical energy, giving priority to the power consumption of the container which will be delivered first.

Accordingly, in a first consideration, the invention concerns an energy management module for a hybrid or an electric vehicle comprising several containers, each container including at least one source of electrical energy connected to the traction system (12) of said vehicle, comprising:
means of analysis that are configured to obtain the state of charge of each source of electrical energy of the containers carried by the vehicle;
a selection module configured to select at least one source of electrical energy intended to power the traction system (12) in order to drive the vehicle, wherein said selection is made so that the electric power is drawn off as a priority from the source of electrical energy of the container to be delivered next by said vehicle when the state of charge of this source of electrical energy is sufficient.

This first consideration of the invention improves the power management of a hybrid or electric vehicle by consuming as a priority the electric power available in a container which will be delivered at the next delivery point. When a container is delivered, and disconnected from the electric network of the vehicle, the source of electrical energy used for transporting the container is also delivered. In this way, managing the power of a hybrid or an electric vehicle reduces the electric consumption of the vehicle which continues to run after delivering the goods.

The source of electrical energy of each container may correspond to a battery, a fuel cell or any other similar device.

In one embodiment, said source of electrical energy management module also includes means of detecting a disconnection of a container, wherein said selection of said at least one source of electrical energy is made once again after the detection of the disconnection of a container. This embodiment allows the power management to be revised when a container is delivered.

In one embodiment, said selection is made so that when the state of charge of said source of electrical energy of the container to be delivered next is less than a threshold value, the electric power is drawn off as a priority from the source of electrical energy of the container delivered after the container to be delivered next. This embodiment allows the power management to be revised when the source of electrical energy being used is discharged or substantially discharged. In addition, the state of charge threshold can also be set as a way of protecting a source of electrical energy from an excessively low discharge condition.

Preferably the vehicle comprises its own source of energy. The source of energy of the vehicle can be a source of electrical energy like a battery set, a fuel cell, or can be a thermal engine or an electric machine driven by a thermal engine of the vehicle.

In one embodiment, said selection is made so that when the state of charge of the sources of electrical energy of all the containers carried by the vehicle is less than a threshold value, the electric power is drawn off from the source of energy of the vehicle.

This embodiment allows the power management to be revised when all the sources of electrical energy being used from the containers are discharged or substantially discharged.

With respect to a second consideration, the invention concerns a method of electrical energy management for a hybrid or an electric vehicle comprising several containers, each container including at least one source of electrical energy connected to the traction system of said vehicle, such method comprising the following steps:
analysis the state of charge of each source of electrical energy of the containers carried by the a vehicle;
selecting at least one source of electrical energy intended to power the traction system in order to drive the vehicle, said selection being made so that the electric power is drawn off as a priority from the source of electrical energy of the container to be delivered next by said vehicle when the state of charge of this source of electrical energy is sufficient.

In one embodiment, said method comprising a step of detecting a disconnection of a container, said selecting step being made once again after the detection of the disconnection of a container.

In one embodiment, said selecting step is made so that, when the state of charge of said source of electrical energy of the container to be delivered next is less than a threshold value, the electric power is drawn off as a priority from the source of electrical energy of the container delivered after the container to be delivered next.

In one embodiment, said selecting step is made so that when the state of charge of the sources of electrical energy of the containers is less than a threshold value, the electric power is drawn off from the source of energy of the vehicle.

With respect to a third consideration, the invention concerns a container with:
a storage space usable for storing goods;
at least one source of electrical energy;
means of connection suitable for connecting said source of electrical energy to an electric network of a vehicle;
a switch, arranged between said source of electrical energy and said means of connection, to connect or disconnect said source of electrical energy and said electric network depending on a command signal from the vehicle.

The third consideration of the invention means that the method of delivering goods in a built-up area can be rethought entirely. Since the goods are delivered with a source of electrical energy used for transporting the goods, it becomes possible for the goods delivery points to recharge the containers.

According to a fourth consideration, the invention concerns a goods transport vehicle including an energy management module according to the first embodiment of the invention and at least one container, said container comprising:
a storage space usable for storing goods with a maximum predetermined load;
at least one source of electrical energy; and
means of connection suitable for connecting said source of electrical energy to a traction system of the vehicle;
said goods transport vehicle comprising a delivery management module configured to set up a delivery route depending on the coordinates of the containers to be delivered or collected.

This fourth consideration of the invention concerns a vehicle, for instance a truck, having means of guiding the driver between several delivery points and informing him of the containers to be delivered or received at each delivery point. As an alternative, the vehicle can be autonomous or semi-autonomous.

According to one embodiment, said vehicle includes a human machine interface, connected to the delivery management module, wherein said delivery management module is capable of changing said delivery route of the vehicle depending on an information received by the human machine interface and that is about new coordinates of containers to be delivered or collected. This embodiment facilitates the transmission of information between a driver and the vehicle delivery management module.

In one embodiment, said delivery management module is connected to a positioning system of the vehicle. This embodiment improves the precision of the delivery management module in using the coordinates of the vehicle in the course of time, by means of a navigation software embedded into the delivery management module.

According to a fifth consideration, the invention concerns a system for delivering goods between several delivery points where the containers must be delivered, said system comprising at least one goods transport vehicle according to the third consideration of the invention.

Overall, this goods delivery system reduces electric power consumption because the vehicle carries a source of power that is correctly sized to meet the transport needs while allowing for the goods being carried by the vehicle.

In one embodiment, the system comprises at least one device for recharging a container. Said device is located at at least one delivery point and/or collection point. This embodiment enables the sites receiving the containers or the sites from which containers have to be collected to recharge the sources of electrical energy. Accordingly, the vehicle can travel while preserving a sufficient on-board power capacity while receiving containers with a recharged source of electrical energy when it delivers containers with the goods to be distributed.

In one embodiment, the system comprises a logistic system. Said at least one goods transport vehicle is configured by the logistic system with the following steps:
determining the volume and weight of the goods to be dispatched at a delivery point;
selecting a container suiting the volume of goods to be dispatched at said delivery point;
calculating a delivery route depending on the coordinates of the different delivery point(s) to which the vehicle must be sent to delivery container(s); and
estimating the required capacity of the source of electrical energy of the container so that the capacity meets the electrical needs for transportation the container and its goods until the delivery point of the goods.

In a second embodiment, wherein the system comprises a logistic system. Said at least one goods transport vehicle is configured by the logistic system with the following steps:
determining the volume and weight of the goods to be dispatched at a delivery point;
selecting a container suiting the volume of goods to be dispatched at said delivery point;
calculating a delivery route depending on the coordinates of the different delivery point(s) to which said goods transport vehicle must be sent to delivery container(s) and/or depending on the coordinates of the collection point(s) to which the vehicle must be sent to collect container(s);
determining if along the delivery route a container with an extra capacity of electrical energy has to be collected before the delivery point of said container to be dispatched at said delivery point;
if yes, estimating the required capacity of the source of electrical energy of the container to be delivered so that the capacity meets the electrical needs for transportation of the container and its goods until the delivery point of the goods, wherein the estimation of the required capacity takes into account said extra capacity of electrical energy that will be used in priority for driving the vehicle until said delivery point.

Preferably, said estimation of the required capacity of the source of electrical energy of the container takes into account the weight of the goods carried by the container.

This embodiment reveals a method for configuring a vehicle, for instance a truck, with containers and sources of electrical energy dedicated to the transportation of goods until a delivery point.

This method can be described as an independent method, according to a first embodiment, for preparing a vehicle including the following steps:
determining the volume and weight of the goods to be dispatched at a delivery point;
selecting a container suiting the volume of goods to be dispatched at said delivery point;
calculating a delivery route depending on the coordinates of the different delivery point(s) to which said goods transport vehicle must be sent to delivery container(s); and
estimating the required capacity of the source of electrical energy of the container so that the capacity meets the electrical needs for transportation the container and its goods until the delivery point of the goods.

The method can be described as an independent method, according to a second embodiment, for preparing a vehicle including the following steps:
determining the volume and weight of the goods to be dispatched at a delivery point;
selecting a container suiting the volume of goods to be dispatched at said delivery point;
calculating a delivery route depending on the coordinates of the different delivery point(s) to which the vehicle must be sent to delivery container(s) and/or depending on the coordinates of the collection point(s) to which the vehicle must be sent to collect container(s);
determining if along the delivery route a container with an extra capacity of electrical energy has to be collected before the delivery point of said container to be dispatched at said delivery point;
if yes, estimating the required capacity of the source of electrical energy of the container to be delivered so that the capacity meets the electrical needs for transportation of the container and its goods until the delivery point of the goods, wherein the estimation of the required capacity takes into account said extra capacity of electrical energy that will be used in priority for driving the vehicle until said delivery point.

### SUMMARY DESCRIPTION OF THE FIGURES

The method of producing the invention and the resulting advantages are evident in the following embodiment, given for information but which is not limiting, supported by the attached figures in which FIGS. 1 to 3 represent:

FIG. 1: a schematic representation of an electric vehicle according to one embodiment of the invention;

FIG. 2: a flowchart of the steps of sizing the containers, sources of electrical energy and a delivery route of the vehicle of FIG. 1; and

FIG. 3: a flowchart of the vehicle power managing steps of FIG. 1.

### DETAILED DESCRIPTION OF THE INVENTION

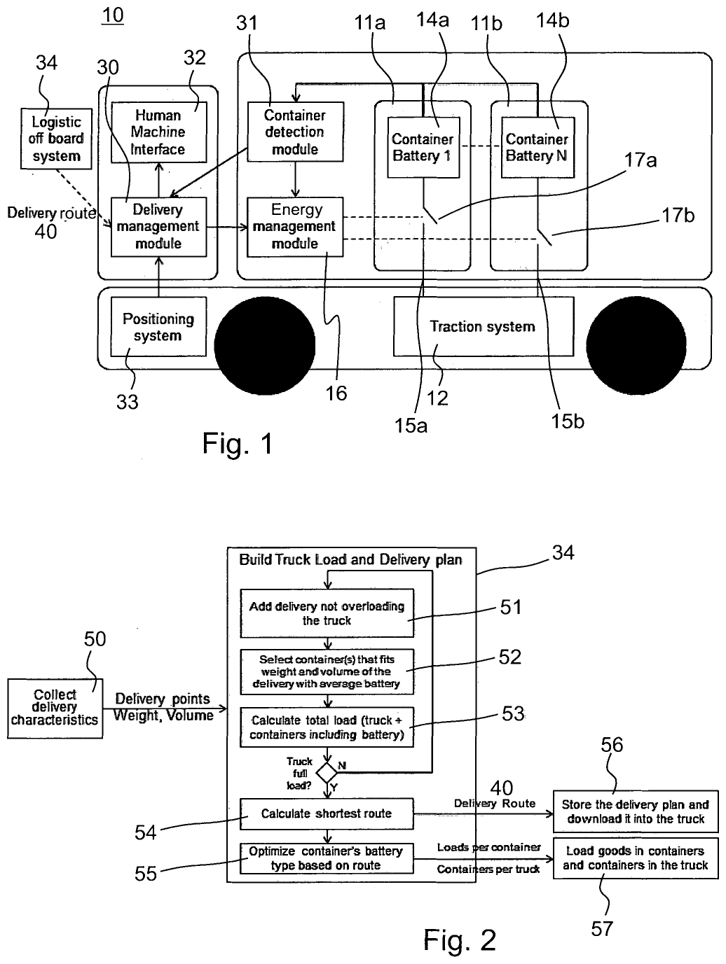

FIG. 1 illustrates a vehicle 10 comprising several containers 11a-11b for transporting goods. Vehicle 10 may correspond to a small truck and the goods containers 11a-11b can be pallets, cases, containers, large capacity sacks or any other similar device.

Vehicle 10 includes a traction system 12 comprising an electric network connected to an electric motor capable of driving the vehicle 10. The electric motor can be the only one driving means, or several complementary driving means may be implemented. A source of energy, for instance a source of electrical energy can also be incorporated in the vehicle 10 and connected to the electric network to supply power to the electric motor when there is no containers 11a-11b on the vehicle 10. The traction system 12 may comprise several electric motors connected to the electric network to drive several trains of the vehicle 10 simultaneously. The traction system 12 may further comprise, in addition of the electric motor, a thermal engine.

Each container 11a-11b includes at least one source of electrical energy 14a-14b and means of connection 15a-15b of the source of electrical energy 14a-14b to the traction system 12 of the vehicle 10. The source of electrical energy 14a-14b of each container 11a-11b may correspond to a battery, a fuel cell or any other similar device. The means of connection 15a-15b may be a simple connector or more complex devices, by physical contact or by induction.

The contact between each source of electrical energy 14a-14b and the traction system 12 is analysed by a detection module 31 of the vehicle 10 configured to detect the presence of electric contact between the source of electrical energy 14a-14b of a container 11a-11b and the traction system 12. For instance, when the contact between a source of electrical energy 14a-14b and the traction system 12 is obtained by a set of male/female connectors, the female socket can include a sensor for detecting the presence of a male connector.

In addition, the detection module 31 can identify several items of information on the source of electrical energy 14a-14b : the type of source of electrical energy 14a-14b, its maximum capacity, its charge condition, its temperature, etc. This detection module 31 corresponds to means of analysis of the sources of electrical energy 14a-14b and can be realized by conventional sensors.

The detection module 31 is connected to an energy management module 16 of the vehicle and to a delivery management module 30. The energy management module 16 controls the switches 17a-17b incorporated into each container 11a-11b for having the traction system 12 take over the source of electrical energy 14a-14b. For this purpose, the energy management module 16 emits a command signal when a switch 17a-17b is commanded. This command signal can be transmitted on a dedicate network, for instance the network CAN, with the address of the switch 17a-17b and the required state. The switches 17a-17b can be controlled by hard wire or radio link and can be embedded in the connection means 15a-15b. In a variant, the switches 17a-17b can be incorporated into the vehicle instead of the container 11a-11b.

Accordingly, the electric motor of the vehicle 10 is powered by one or several sources of electrical energy 14a-14b using a strategy defined by the energy management module 16.

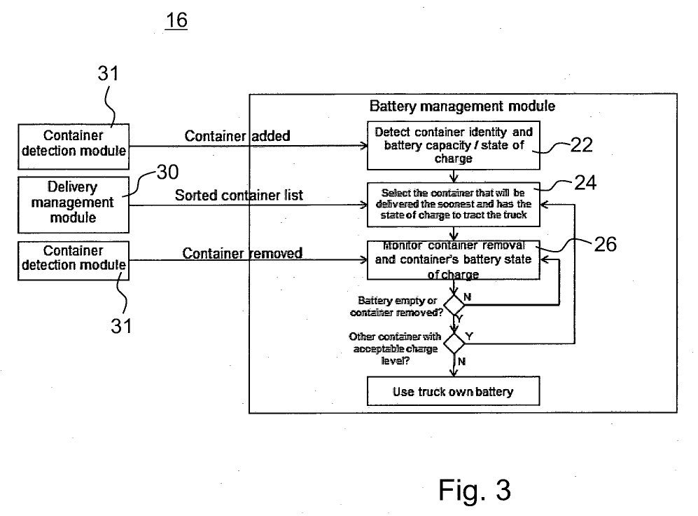

As illustrated in FIG. 3, the supply strategy of the electric motor is defined by a first step 22 consisting in detecting and identifying each container 11a-11b and the capacity of each source of electrical energy 14a-14b and the state of charge of these sources of electrical energy 14a-14b. First step 22 is carried out by the detection module 31.

Depending on the containers 11a-11b carried by the vehicle 10, the energy management module 16 selects, among the different available sources of energy 14a-14b, the source of electrical energy to be used so that the electric power is drawn off as a priority from the source of electrical energy of the container to be delivered next by the vehicle 10 if the state of charge of this source of electrical energy is sufficient.

To do this, the energy management module 16 receives a list containing the order in which the containers 11a-11b will be delivered, from the delivery management module 30. For instance, the first container on the list corresponds to the designation of container 11a-11b to be delivered next. The energy management module 16 seeks whether the charge condition of this source of electrical energy 14a-14b of this container 11a-11b is higher than a threshold, for instance, 5% of its maximum capacity.

If its capacity is above this threshold, the source of electrical energy 14a-14b is used to supply power to the electric motor of vehicle 10 and the associated switch 17a-17b is closed. If its capacity is insufficient, the source of electrical energy 14a-14b of the container which will next be delivered is used if its charge is sufficient, and so on.

When there is no source of electrical energy 14a-14b in place or if none of the sources of electrical energy 14a-14b is sufficient, the managing device 16 commands the use of the source of energy that is internal to the vehicle 10. The source of energy of the vehicle 10 can be a source of electrical energy like a battery set, a fuel cell or can be a thermal engine or an electric machine driven by a thermal engine of the vehicle.

As an alternative, several sources of electrical energy 14a-14b can be used to complement the source of electrical energy corresponding to the container which will be delivered first, for instance to limit the discharging time of this source of electrical energy or to recharge a source of electrical energy on the vehicle 10.

In addition, changing the source of electrical energy 14a-14b used by the vehicle 10 can be carried out when the first module 31 detects 22 that the state of charge of the active source of electrical energy 14a-14b drops below the threshold or when a module 31 detects 26 that a source of electrical energy 14a-14b is disconnected from the traction system 12 or when the vehicle collects on its route a container with an extra capacity of electrical energy that is used in priority.

In addition, the delivery management module 30 is configured to set up a delivery route, also called a delivery plan, for the vehicle 10 depending on the locations of the delivery points at which the containers 11a-11b must be delivered or collected.

This delivery management module 30 can be connected to a positioning system 33 and to a human machine interface 32 to enable the driver to change the delivery route of the vehicle 10 and obtain information for effecting delivery and reception operations.

Preferably before the departure of the vehicle 10, the delivery management module 30 receives a delivery route 40 dispatched by a logistic off-board system 34 of an overall goods delivery system encompassing several delivery points.

As shown in the example of FIG. 2, depending on the demands of each delivery point 50, the logistics system 34 determines the volume and weight of the goods to be dispatched to the various delivery points. For each requested delivery point, a first step 51 consists in checking that the goods corresponding to the demand can be transported by the vehicle 10 without exceeding the load limit of the vehicle 10. If a load limit is reached, the goods corresponding to the demand must be transported by another vehicle 10 or by several independent vehicles. If the load limit is not reached, the second step 52 consists in selecting a container 11a-11b suiting the volume of goods and preferably also the type of goods and the weight of goods. A third step 53 estimates the new load of the vehicle 10 to determine whether the vehicle 10 can transport other goods.

For all the orders of a vehicle 10, the logistic off-board system 34 transmits, during a fourth step 54, a delivery route 40 depending on the coordinates of the various delivery points to which the vehicle 10 must be sent. Quite simply, this delivery route 40 may consist in following the shortest route between the delivery points. This delivery route 40 can also be far more complex, seeking to ensure priority delivery to delivery points with sensitive goods, in attempting to avoid routes where there is heavy traffic, in seeking to optimise the reception of containers 11a-11b for the transport of containers 11a-11b. When the delivery route 40 has been determined, it is dispatched to the delivery management module 30 of the vehicle 10. In addition, the vehicle 10 can be wirelessly connected to the logistic off-board system 34 so that the delivery route 40 can be modified remotely, for instance, to deal with an urgent order.

Furthermore, when the containers 11a-11b have been selected has the suitable ones, the logistic off-board system 34 configures, during a step 55, the source of electrical energy 14a-14b required for transporting each container 11a-11b.

Preferably, the source of electrical energy 14a-14b is configured so that it has sufficient capacity based at least on the weight of goods carried by the container, preferably on the total weight of each container 11a-11b to meet the electrical needs for transporting the container 11a-11b and its goods, when a transport route is defined in said delivery route 40.

According to previously mentioned step fourth step 54, the delivery route 40 can be calculated depending also on some points of collect where some containers, loaded or unloaded with goods, can be collected at different collection points. In the latter case, the logistic system 34 receives an information about the state of charge of the container to be collected and an information relative to the weight of eventual goods carried by the container to be collected. This information can be received, for instance, from the container to be collected itself via a wireless communication or via a container management system located at the point of collection of the container.

With information relative to the state of charge of the container to be collected and information relative to the weight of eventual goods it carries, the logistic system 34 is able to determine if the container to be collected has a sufficient capacity to meet the electrical needs for its transportation until its delivery point.

The logistic system 34 can also determine when the source of electrical energy of the container to be collected has an extra capacity of electrical energy. In other words, the logistic system 34 can also determine when the source of electrical energy of the container to be collected has already been charged with a quantity of electrical energy or has a current state of charge that exceeds the electrical needs for the transportation of the collected container until its delivery point.

If along the delivery route 40 at least one container has to be collected, if it is determined that the container to be collected has an extra capacity of electrical energy and if it is planned along the delivery route 40 to collect the container to be collected before the delivery point of a container that has to be delivered along the delivery route,

the logistic system 34 estimates the required capacity of the source of electrical energy of the container to be delivered so that the capacity meets the electrical needs for transportation of the container and its goods until the delivery point of the goods. Furthermore, for this estimation of the required capacity of the source of electrical energy of the container to be delivered the logistic system 34 takes into account the extra capacity of electrical energy that will be received from the container to be collected. Indeed, in this case the energy management module 16, will decide to draw off as a priority electrical energy received from the source of electrical energy of the collected container to cover at least partially the electrical needs for transportation of the container to be delivered until the delivery point of its goods.

Thanks to this method, the source of electrical energy to transport can be selected accurately regarding its capacity, allowing to choose a lighter source of electrical energy that finally results in energy savings.

Finally, during a last step 57, the logistic off-board system 34 charges each container 11a-11b on the vehicle 10.

The invention improves the electrical consumption of a vehicle 10 because the vehicle 10 travels with sources of electrical energy 14a-14b having a capacity specifically adjusted to the weight of the goods being transported.

1. An energy management module for a hybrid or an electric vehicle comprising several containers, each container including at least one source of electrical energy connected to the traction system of said vehicle, such energy management module comprising:
means of analysis that are configured to obtain the state of charge of each source of electrical energy of the containers carried by the vehicle; a selection module configured to select at least one source of electrical energy intended to power the traction system wherein said selection is made so that the electric power is drawn off as a priority from the source of electrical energy of the container to be delivered next by said vehicle when the state of charge of this source of electrical energy is sufficient.

2. An energy management module according to claim 1, wherein said energy management module also includes means of detecting a disconnection of a container, wherein said selection is made once again after the detection of the disconnection of a container.

3. An energy management module according to claim 1, wherein said selection is made so that, when the state of charge of said source of electrical energy of the container to be delivered next is less than a threshold value , the electric power drawn off as a priority from the source of electrical energy of the container delivered after the container to be delivered next.

4. An energy management module according to claim 1, wherein said vehicle comprises its own source of energy and wherein said selection is made so that when the state of charge of the sources of electrical energy of the containers is less than a threshold value, the electric power is drawn off from the source of energy of the vehicle.

5. Method of electrical energy management for a hybrid or an electric vehicle comprising several containers, each container including at least one source of electrical energy connected to the traction system of said vehicle, such method comprising the following steps:
analysis the state of charge of each source of electrical energy of the containers carried by the vehicle;
selecting at least one source of electrical energy intended to power the traction system, said selection being made so that the electric power is drawn off as a priority from the source of electrical energy of the container to be delivered next by said vehicle when the state of charge of this source of electrical energy is sufficient.

6. Method according to claim 5, in which said method comprising a step of detecting a disconnection of a container, said selecting step being made once again after the detection of the disconnection of a container.

7. Method according to claim 5, in which said selecting step is made, so that when the state of charge of said source of electrical energy of the container to be delivered next is less than a threshold value, the electric power is drawn off as a priority from the source of electrical energy of the container delivered after the container to be delivered next.

8. Method according to claim 5, in which said vehicle comprises its own source of energy and wherein said selecting step is made so that when the state of charge of the sources of electrical energy of the containers is less than a threshold value, the electric power is drawn off from the source of energy of the vehicle.

9. A container comprising:
a storage space usable for storing goods;
at least one source of electrical energy; and
means of connection suitable for connecting said source of electrical energy to a traction system of a vehicle;
characterised in that said container comprises a switch, arranged between said source of electrical energy and said means of connection, to connect or disconnect said source of electrical energy and said traction system depending on a command signal from the vehicle.

10. A goods transport vehicle including an energy management module according to claim 1 and at least one container, said container comprising:
a storage space usable for storing goods;
at least one source of electrical energy; and
means of connection suitable for connecting said source of electrical energy to a traction system of the vehicle;
said goods transport vehicle comprising a delivery management module configured to set up a delivery route depending on the coordinates of the containers to be delivered or collected.

11. A goods transport vehicle according to claim 10, in which said vehicle includes a human machine interface, connected to the delivery management module, wherein said delivery management module is capable of changing said delivery route of the vehicle depending on an information received by the human machine interface and that is about new coordinates of containers to be delivered or collected.

12. A goods transport vehicle according to claim 10, in which said delivery management module is connected to a positioning system of vehicle.

13. A system for delivering goods between several delivery points where the containers must be delivered, said system comprising at least one goods transport vehicle according to claim 10.

14. A system for delivering goods according to claim 13, wherein the system comprises at least one device for recharging a container located at at least one delivery points and/or at least one collection point.

15. A system for delivering goods according to claim 13, wherein the system comprises a logistic system and wherein said at least one goods transport vehicle is configured by the logistic system with the following steps:
determining the volume and weight of the goods to be dispatched at a delivery point;
selecting a container suiting the volume of goods to be dispatched at said delivery point;
calculating a delivery route depending on the coordinates of the different delivery point(s) to which the goods transport vehicle must be sent to deliver container(s); and
estimating the required capacity of the source of electrical energy of the container so that the capacity meets the electrical needs for transportation the container and its goods until the delivery point of the goods.

16. A system for delivering goods according to claim 13, wherein the system comprises a logistic system and wherein said at least one goods transport vehicle is configured by the logistic system with the following steps:
determining the volume and weight of the goods to be dispatched at a delivery point;
selecting a container suiting the volume of goods to be dispatched at said delivery point;
calculating a delivery route depending on the coordinates of the different delivery point(s) to which the goods transport vehicle must be sent to delivery container(s) and/or depending on the coordinates of the collection point(s) to which the vehicle must be sent to collect container(s);
determining if along the delivery route a container with an extra capacity of electrical energy has to be collected before the delivery point of said container to be dispatched at said delivery point;
if yes, estimating the required capacity of the source of electrical energy of the container to be delivered so that the capacity meets the electrical needs for transportation of the container and its goods until the delivery point of the goods, wherein the estimation of the required capacity takes into account said extra capacity of electrical energy that will be used in priority for driving the vehicle until said delivery point.

17. A system for delivering goods according to claim 15, wherein the estimation of the required capacity of the source of electrical energy of the container takes into account the weight of the goods carried by the container.
